(19) United States
(12) Patent Application Publication
(10) Pub. No.: US 2019/0333155 A1
(43) Pub. Date: Oct. 31, 2019

(54) HEALTH INSURANCE COST PREDICTION REPORTING VIA PRIVATE TRANSFER LEARNING

(71) Applicant: INTERNATIONAL BUSINESS MACHINES CORPORATION, Armonk, NY (US)

(72) Inventors: Karthikeyan Natesan Ramamurthy, Culver City, CA (US); Emily A. Ray, Hastings on Hudson, NY (US); Dennis Wei, White Plains, NY (US); Gigi Y.C. Yuen-Reed, Tampa, FL (US)

(21) Appl. No.: 15/964,856

(22) Filed: Apr. 27, 2018

(51) Int. Cl. G06Q 40/08; G06N 99/00

(52) U.S. Cl. CPC G06Q 40/08; G06N 99/005

(57) ABSTRACT

A method, computer system, and a computer program product for generating and reporting a plurality of health insurance cost predictions via private transfer learning is provided. The present invention may include retrieving a set of source data, and a set of target data. The present invention may then include creating and anonymizing a plurality of source data sets, and at least one target data set. The present invention may further include generating one or more source learner models, and a target learner model. The present invention may then include combining the one or more generated source learner models and the generated target learner model to generate a transfer learner. The present invention may further include generating a prediction based on the generated transfer learner.

### BACKGROUND

The present invention relates generally to the field of computing, and more particularly to the transfer of health insurance cost prediction reporting without violating Health Insurance Portability and Accountability Act (HIPAA) compliance or data ownership or any other data policies of the stakeholders.

Data policies and regulations may include anonymized data, or the data may be unable to move from the original location. Health insurance cost data may be noisy and may require advanced analytics like machine learning techniques to make future cost predictions with a reasonable amount of accuracy. Features that contribute to the cost of health insurance utilization may exist in a very large feature space with a large quantity of samples to perform pattern analysis and prediction. Health insurance cost historical data may often be limited to a small number of people in a provider's plan area compared to what may be necessary to perform accurate cost prediction due to, among other factors, company size and coverage area, retention and turnover of customers from job and locality changes.

### SUMMARY

Embodiments of the present invention disclose a method, computer system, and a computer program product for generating and reporting a plurality of health insurance cost predictions via private transfer learning. The present invention may include retrieving a set of source data from at least one private source database, and a set of target data from a private target database. The present invention may then include creating a plurality of source data sets from the retrieved set of source data, and at least one target data set from the retrieved set of target data. The present invention may also include anonymizing the created plurality of source data sets, and at least one created target data set. The present invention may further include, in response to determining that at least one anonymized source training data set and at least one anonymized target training data set is created, generating one or more source learner models based on the anonymized source training data set, and a target learner model based on the anonymized target training data set. The present invention may then include combining the one or more generated source learner models and the generated target learner model to generate a transfer learner. The present invention may further include generating a prediction based on the generated transfer learner, wherein the generated prediction is evaluated for quality.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for reporting predicted health insurance cost via private transfer learning according to at least one embodiment;

FIG. 3 is an operational flowchart illustrating a process for implementing access levels for a user without exposing source database data according to at least one embodiment;

FIG. 4 is an operational flowchart illustrating a process for performing target and source data modelling according to at least one embodiment;

FIG. 5 is an operational flowchart illustrating a process for utilizing a combiner to generate a predictive model according to at least one embodiment;

FIG. 6 is a block diagram of internal and external components of computers and servers depicted in FIG. 1 according to at least one embodiment;

FIG. 7 is a block diagram of an illustrative cloud computing environment including the computer system depicted in FIG. 1, in accordance with an embodiment of the present disclosure; and

FIG. 8 is a block diagram of functional layers of the illustrative cloud computing environment of FIG. 7, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, Python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for generating and reporting health insurance cost predictions via private transfer learning. As such, the present embodiment has the capacity to improve the technical field of health insurance cost prediction reporting without violating HIPAA compliance or data ownership or any other data policies of stakeholders. The present embodiment may also enhance the predictability of a data model by transferring knowledge from one or more data sets in which the health insurance cost prediction program may have restricted direct access, or segregation may be necessary. More specifically, the health insurance cost prediction program may retrieve and format data, and then anonymize the retrieved and formatted data. The anonymized data may then be utilized to create a data set in which training data may be utilized to generate a learning module, which may be used with the test data to infer the predicted costs. The trained health insurance cost reporting program may then utilize the predicted costs to generate a report to present to an end user.

As previously described, data policies and regulations may include anonymized data, or the data may be unable to move from the original location. Health insurance cost data may be noisy and may require advanced analytics like machine learning techniques to make future cost predictions with a reasonable amount of accuracy. Features that contribute to the cost of health insurance utilization may exist in a very large feature space with a large quantity of samples to perform pattern analysis and prediction. Health insurance cost historical data may often be limited to a small number of people in a provider's plan area compared to what may be necessary to perform accurate cost prediction due to, among other factors, company size and coverage area, retention and turnover of customers from job and locality changes.

Additionally, transfer learning from another data source may increase the accuracy of a predictive model on a target data set. The transfer learning may exclude the direct exposure of the source data, thereby enabling a model transfer from one company's data to another without violating HIPAA compliance or data ownership or other data policies of stakeholders.

Therefore, it may be advantageous to, among other things, improve the predictability of a data model by utilizing knowledge derived from data sets that the health insurance cost prediction program may be excluded from direct access to or needs to segregate for some reason.

According to at least one embodiment, the health insurance cost prediction program may generally provide for mapping data in two feature spaces generated from at least two distinct data sets. The present embodiment may include maintaining access to multiple sets of source and a single target data set while segregating source data from an end user (i.e., a person or entity who has a stake in the target database. For other types of users, a target database may also be anonymized and predictions may be provided on-demand for specific data points utilizing the trained models). The health insurance cost prediction program may provide for multi-level data separation including anonymization to access other data, or limiting access to data models, final models or specific access levels.

According to at least one embodiment, the health insurance cost prediction program may filter data by samples with model compatibility and may perform transfer learning between one or more source models and a target model associated with target data to predict health insurance cost at given future intervals. The health insurance cost prediction program may further summarize source data, subject to privacy settings, based on target data to improve quality of one or more source models with respect to desired target performance. The present embodiment may include modification of the transfer learning combiner algorithm and may be able to address data policy constraints as required by HIPAA for anonymization.

According to at least one embodiment, the health insurance cost prediction program may satisfy the data policy and privacy constraints by prohibiting the storage of source and target data sets in the same database, since the source and target data sets may belong to different customers. Therefore, the source and target data sets may be securely stored away from each other. Additionally, the health insurance cost prediction program may be prohibited from combining anonymized data from source and target data sets retrieved from the same database.

According to at least one embodiment, the health insurance cost prediction program may be permitted to combine anonymized data from source and target data sets retrieved from the same database based on relaxed data policy constraints. For example, if the health insurance cost prediction program uses anonymized data, a group of individuals of a specified size are indistinguishable from each other.

According to at least one embodiment, the health insurance cost prediction program may utilize pooled anonymized data to learn predictors for the target data, when multiple anonymized data sets are present and data distributions are preserved.

The present embodiment may generally provide for a processing pipeline that pulls data from a private source database to create a training or testing data set. The retrieved data may be anonymized before moving through a learning module that generates a source learner model (i.e., a data model generated based on the initial training). Through a similar process, data may be retrieved from a private target database to create a training or testing data set, which may then be anonymized. The anonymized data set may then move through a learning module to generate a target learner model. The source learner model and the target learner model may be combined utilizing a combiner module to generate a transfer learner model, which may then be provided to a prediction module. The prediction module may then evaluate the target test data with the transfer learner model to generate appropriate reports (i.e., reports are usually generated for the target data and not the source data).

According to at least one embodiment, the health insurance cost prediction program may improve the predictive performance with the target data set by utilizing additional knowledge from the source data set. The present embodiment may include a distinction between the target data sets in which there may be two types of target data sets: deficient target data sets and true target data sets. The two types of target data sets may have the same features, but are only similar and not the same, as quantified by some distance measure between the data distributions. However, the source and target data sets (both deficient and true) may share the same domain, with overlapping, although different, supports. Additionally, since the true target may be unknown, the predictive models (i.e., source and target learner models) may be trained with source and deficient target training data sets to obtain a predictive model for the true target.

According to at least one embodiment, the health insurance cost prediction program may utilize training data (e.g., source training data or target training data) to learn or train a model (e.g., source learner model or target learner model), and the test data (e.g., source test data or target test data) may be utilized to obtain predictions for the generated reports.

According to at least one embodiment, the health insurance cost prediction program may obtain data from a source training data set that may be utilized to build a predictive model. More than one source data or model may be used. Anonymization may be implemented as necessary to comply with data policy regulations. The health insurance cost prediction program may separate historical health insurance claims data sets into different train and test data. The train data may be utilized to build a predictive model. A combiner may align and filter data to make the models compatible, then may learn a set of weights and methods to combine target and source models to the target test data. The weights may vary on the group or member level, and more than one source level may be used. The combiner model type may be chosen by the user or automatically selected based on performance. A prediction for future costs may then be made. The present embodiment may include limiting access to source models for passage to the transfer pipeline for heightened privacy between databases (i.e., access limitations are usually solely with data sets, and models may be assumed to be available to the transfer pipeline).

According to at least one embodiment, the health insurance cost prediction program may implement access levels. The health insurance cost prediction program may interface with an end user by utilizing a first set of access layers to provide access to source models and corresponding databases (1-n) by the processing pipeline. The processing pipeline may include a data preparation pipeline, an anonymization engine, a model trainer engine, a combiner engine, a transfer learner engine, and a prediction and evaluation engine. The processing pipeline also may interface with a target database and exclude exposure of the source databases to the target database or to the end user. Therefore, the user may be able to receive model predictions and model performance information from the processing pipeline without seeing the source data associated with the private source database.

According to at least one embodiment, the health insurance cost prediction program may include the performance of target and source data modelling (i.e., the input of a predictive model may be a data set that includes features about the members enrolled in health insurance plans, and the output may be the predicted costs). The data may be retrieved from the database and formatted, and thereafter anonymized. The anonymized data may be used to create training and test data sets. The training data set may be provided to a model learner that generates a learned predictor that may be provided to a prediction module. The prediction module may receive, therefore, the output of the learner. The prediction module may also receive, separately, the test data set. The prediction module may apply the learned predictor, derived from the training data set, to the test data set, and generate predictions.

The present embodiment may include the combination of functions associated with the target and source models. Initially, an updated source model may be generated by receiving, as inputs, a feature mapping and a population shifted data set. The population shifted data set may be obtained using the summary statistics derived from the target test data. The updated source model and the target model may then be examined to identify the set of common features. The samples, without common features, may then be mapped. Then, the remaining data with common features may be used as input into the transfer learner module. The data may then be used to generate predictions that may be output from the transferred model. The dropped data may then be used to obtain predictions from the target model. The predictions from the target model and predictions from the transfer model may be recombined to generate a predictive model, which may then be used in performance evaluation.

According to at least one embodiment, the health insurance cost prediction program may predict the likely utilization cost (i.e., future health insurance costs), and the health insurance cost prediction program may utilize multiple data sources (i.e., multiply-owned data sources) to allow for performance improvement via transfer learning. The health insurance cost prediction program may further utilize multiple data sets to support existing desired features. In the present embodiment, the health insurance cost prediction program may prohibit the exposure of the original data to the new processing pipelines to prevent to the violation of data access restrictions defined by the data access policies and legal regulations.

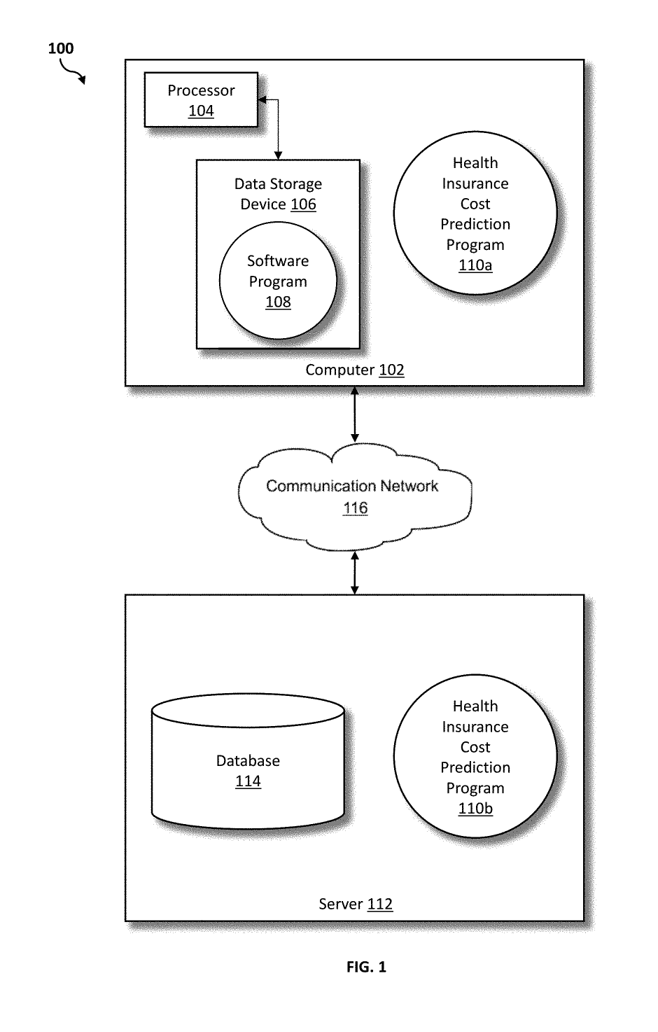

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a health insurance cost prediction program 110a. The networked computer environment 100 may also include a server 112 that is enabled to run a health insurance cost prediction program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

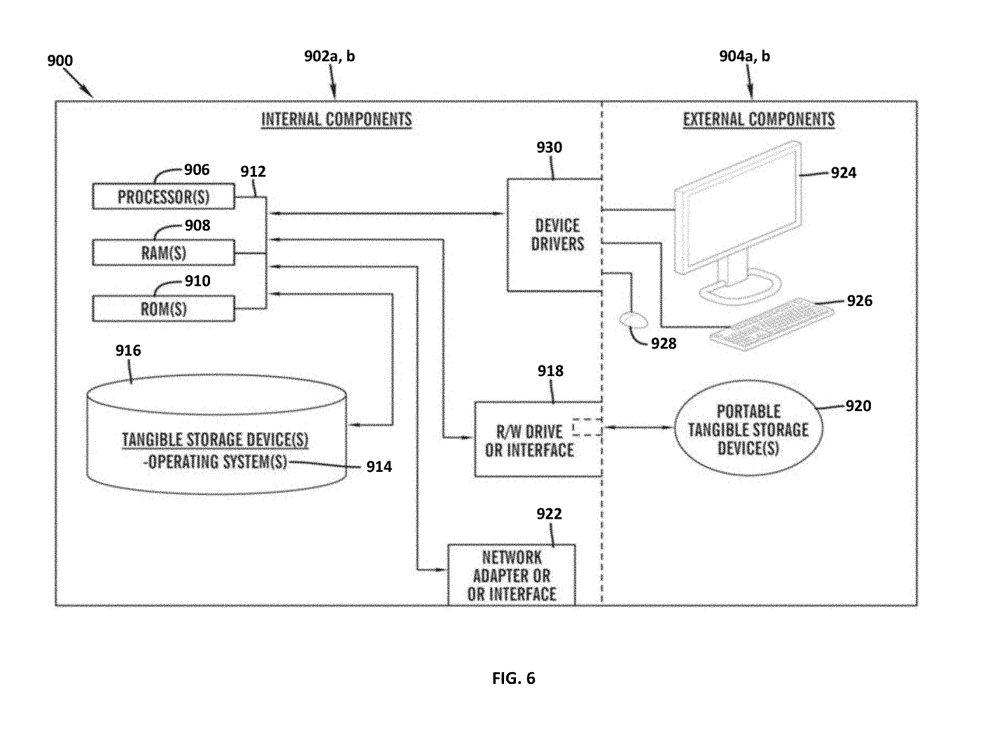

The client computer 102 may communicate with the server computer 112 via the communications network 116. The communications network 116 may include connections, such as wire, wireless communication links, or fiber optic cables. As will be discussed with reference to FIG. 6, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the health insurance cost prediction program 110a, 110b may interact with a database 114 that may be embedded in various storage devices, such as, but not limited to a computer/mobile device 102, a networked server 112, or a cloud storage service.

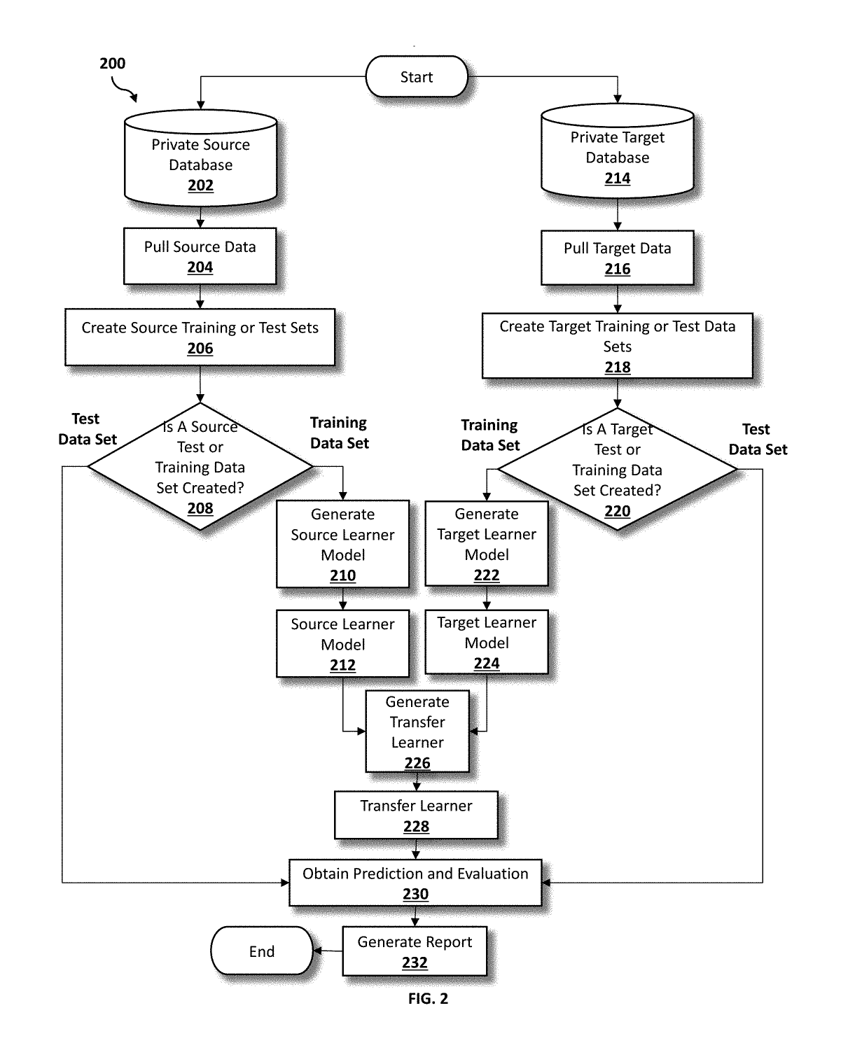

According to the present embodiment, a user using a client computer 102 or a server computer 112 may use the health insurance cost prediction program 110a, 110b (respectively) to improve health insurance cost predictions via private transfer learning. The health insurance cost prediction method is explained in more detail below with respect to FIGS. 2-5.

Referring now to FIG. 2, an operational flowchart illustrating the exemplary health insurance cost prediction reporting via private transfer learning process 200 used by the health insurance cost prediction program 110a, 110b according to at least one embodiment is depicted.

At 204, source data is pulled from a private source database 202. Using a software program 108 on the user's device (e.g., user's computer 102), the health insurance cost prediction program 110a, 110b may provide for a processing pipeline (e.g., a set of data processing elements connected in series, where the output of one element is the input of the next) to load (i.e., pull or retrieve) a piece of source data as input from a private source database 202 (e.g., database 114) via communications network 116. The source data may include an information-rich database available to train information-rich (or information dense) source models. The health insurance cost prediction program 110a, 110b may include multiple source data sets that may be leveraged.

In the present embodiment, the health insurance cost prediction program 110a, 110b may prompt the user (e.g., via dialog box) to provide details or parameters that may customize the source data. Once the user starts the health insurance cost prediction program 110a, 110b, the user may be prompted (e.g., via dialog box) to indicate whether the user has any parameters or details to customize the source data. The dialog box may include a list of possible parameters (e.g., treatment, medications). The user may then click on the button located to the left of the possible parameters, which may expand the dialog box, and the user may be prompted (e.g., via the same dialog box) to provide details related to the selected parameters. The dialog box may expand and prompt the user to confirm the selected parameter and provided details by clicking the “Yes” or “No” buttons under a statement restating the selected parameter and provided details. Once the user clicks “Yes,” the dialog box may disappear. If, however, the user selects the “No” button, then the dialog box may remain for the user to clarify the selected parameters and provided details.

For example, the user wants to predict the health care costs for a data set associated with Customer A, who recently underwent a quadruple bypass heart surgery. However, the user only has access to data associated with a few thousand members, which is not sufficient to make an accurate prediction on the health care costs for Customer A. As such, the user utilizes the health insurance cost prediction program 110a, 110b, which has access to much richer source data associated with millions of members. The richer source data is stored in a database that a third-party compiled for research purposes from claims, electronic medical records, clinical records and other specialty records related to various patients (i.e., members or groups). Therefore, the user limits the source data to patients that have undergone a quadruple bypass heart surgery within the past year.

Then, at 206, at least one source training or test data set is created. The pulled data may then be utilized to create at least one source training or test data set. The created source training or test data set may then be anonymized before moving through a learning module that generates a source learner model. Anonymization (i.e., information sanitization that may be implemented for privacy protection, which may include encryption or removal of personally identifiable information from data sets to preserve the anonymity of a person associated with the data) of the created source training or test data set may necessary to comply with data policy regulations (e.g., HIPAA).

Continuing the previous example, the health insurance cost prediction program 110a, 110b first pulls the richer source data associated with millions of members based on the user's specific requests (i.e., claims related to a quadruple bypass surgery), and creates a source data set. Then, the health insurance cost prediction program 110a, 110b anonymizes the pulled and created source data sets in accordance with data policy constraints. As such, personal identifiers (i.e., social security numbers, names, addresses, member identification numbers) are removed from the richer source data sets.

Then, at 208, the health insurance cost prediction program 110a, 110b determines whether at least one source test or training data set is created. The health insurance cost prediction program 110a, 110b may receive input on whether the created data set is a source test or training data set from the user. The health insurance cost prediction program 110a, 110b may utilize the data set differently. The source training data set may be utilized to learn or train a predictive model (i.e., source learner model), while a source test data set may be utilized to obtain predictions and evaluate the quality of predictions. The true outputs for the source test data sets may be unknown by the health insurance cost prediction program 110a, 110b, whereas for the source training data set, the output may be generally known by the health insurance cost prediction program 110a, 110b.

In the present embodiment, the source training data set or target training data set may be used to train the parameters of the prediction algorithm. Predictions may be obtained with the source test data set or target test data set. The ground truth outcomes associated with the source test data set or target test data set may be either unknown or masked for the purposes of obtaining the predictions. Besides the differences in the use of each type of data set, the input features in training and test data sets (e.g., either target or source) may be the same. For example, the input features in a data set include the demographics of the patients, health insurance plan details, prior healthcare costs, and medical codes (diagnoses, procedures, drugs), and the outcome variable will be the yearly claims cost. An additional example of training and test data are third-party commercial claims and encounters data.

In the present embodiment, the user may be prompted (e.g., via dialog box) by the health insurance cost prediction program 110a, 110b to provide whether the created data set is a source test or training data set. The dialog box may include a question asking the user whether the created data set is a source test or training data set. The user may select either the “Test” or “Training” button under the question in the dialog box. Once the user clicks the appropriate button, the dialog box may disappear.

If the health insurance cost prediction program 110a, 110b determines that at least one source training data set is created at 208, then the created source training data set is used to generate a source learner model 212 at 210. The health insurance cost prediction program 110a, 110b may utilize a source learning module to generate a source learner model 212 (i.e., a predictive model) associated with the created and anonymized source training data set.

Continuing the previous example, the health insurance cost prediction program 110a, 110b determines that the source data sets include both training and test data sets. As such, the health insurance cost prediction program 110a, 110b utilizes the source training data set to train a source learner model to learn patterns in the health care costs associated with patients that have undergone a quadruple bypass heart surgery within the past 12 months. As such, the source learner model 212 learns patterns related to, among other factors (i.e., features), the patient's age, hospital location, prior health status, and medical complications (if any) to determine the differences in health care costs, and to predict the health care costs associated with another patient who has undergone a quadruple bypass heart surgery within the past 12 months.

In another embodiment, the health insurance cost prediction program 110a, 110b may be prohibited from updating the source learner model 212.

Then, at 216, the health insurance cost prediction program 110a, 110b pulls target data from a private target database 214 simultaneously with pulling source data at 204. Using a software program 108 on the user's device (e.g., user's computer 102), the health insurance cost prediction program 110a, 110b may provide for the processing pipeline to load (i.e., pull or retrieve) a piece of target data as input from a private target database 214 (e.g., database 114) via communications network 116. The target data (e.g., the data that the health insurance cost prediction program 110a, 110b may intend to obtain a prediction based on) may typically be less information-rich compared to the source data set, thereby necessitating transfer learning.

Continuing the previous example, the target data is the data associated with Customer A, which is stored in the private target database on a private web-based cloud. As such, the user is able to utilize a software program to upload the data associated with Customer A into the health insurance cost prediction program 110a, 110b.

In another embodiment, the health insurance cost prediction program 110a, 110b may pull the source data from the private source database 202 at 204 and pull the target data from the private target database 214 at 216 consecutively. For example, the health insurance cost prediction program 110a, 110b may pull the source data at 204 before pulling the target data at 216, or the health insurance cost prediction program 110a, 110b may pull the target data at 216 before pulling the source data at 204.

Then, at 218, at least one target training or test data set is created. The pulled target data may then be utilized to create at least one target training or test data set. The created target training or test data set may then be anonymized before a determination on whether a target training or test data set is created by the health insurance cost prediction program 110a, 110b. Similar to the anonymization of the created source training or test data sets at 206, the anonymization of the created target training or test data set may be implemented to comply with data policy regulations (e.g., HIPAA).

Continuing the previous example, the health insurance cost prediction program 110a, 110b first pulls the uploaded target data associated with Customer A, and creates a target data set. Then, the health insurance cost prediction program 110a, 110b anonymizes the pulled and created target data sets in accordance with data policy constraints. As such, personal identifiers (i.e., social security number, name, home address, member identification number, telephone numbers, emergency contact information) are removed from the target data sets associated with Customer A.

Then, at 220, the health insurance cost prediction program 110a, 110b determines whether at least one target test or training data set is created. Similar to the source test and training data sets, the health insurance cost prediction program 110a, 110b may receive input on whether the created data set is a target test or training data set from the user. Historical health insurance claims data sets from different targets may be separated into a target training data set or a test data set, which the health insurance cost prediction program 110a, 110b, similar to the source test and training data sets, may treat differently. The target training data set may be utilized to learn or train a predictive model (i.e., target learner model), while a target test data set may be utilized to obtain predictions and evaluate the quality of predictions. The true outputs for the test data sets may be unknown by the health insurance cost prediction program 110a, 110b, whereas for the training data set, the output may be generally known by the health insurance cost prediction program 110a, 110b.

In the present embodiment, the user may be prompted (e.g., via dialog box) by the health insurance cost prediction program 110a, 110b to provide whether the created data set is a target test or training data set. The dialog box may include a question asking the user whether the created data set is a target test or training data set. The user may select either the “Test” or “Training” button under the question in the dialog box. Once the user clicks the appropriate button, the dialog box may disappear.

If the health insurance cost prediction program 110a, 110b determines that at least one target training data set is created at 220, then the created target training data set is used to generate a target learner model 224 at 222. Similar to the source learner model 212, the health insurance cost prediction program 110a, 110b may utilize a target learning module to generate a target learner model 224 based on the created and anonymized target training data set.

Continuing the previous example, the health insurance cost prediction program 110a, 110b determines that the target data sets associated with Customer A include both target training and test data sets. As such, the target training data sets associated with Customer A are utilized to generate a target learner model 224 to search the data sets for various factors that will affect the health care costs, such as the medical complications that the patient experienced during the quadruple bypass heart surgery, the fact that Customer A is 41 years old and that the quadruple bypass heart surgery was performed by two of the most experienced and prestigious cardiac surgeons affiliated with the hospital.

Then, at 226, the generated source learner model 212 and the generated target learner model 224 are combined to generate a transfer learner 228. The generated source learner model 212 and generated target learner model 224 may be combined, by utilizing a combiner, to generate the transfer learner 228. Generally, the combiner (i.e., a machine learning model) may combine the predictions of the source learner model 212 and target learner model 224 to provide an output prediction. The combiner may first align and filter data to make the source learner model 212 and the target learner model 224 compatible. The combiner may then learn an optimal combination of a set of weights and methods to combine the source learner model 212 and the target learner model 224 to evaluate the created and anonymized target test data set. The weights may vary, and may be global (i.e., a combination of weight for records, samples or members), member level (i.e., a combination of weight change for each member), or group level (i.e., a combination weight change for each pre-defined member cohort).

In the present embodiment, the combiner utilized by the health insurance cost prediction program 110a, 110b may include more than one source learner model 212 from the created and anonymized source training data sets to generate the transfer learner 228.

In the present embodiment, the combiner type model (e.g., linear regression, classification) may be selected by a user, or automatically selected based on performance. The combiner may be specified by the user. The user may also mandate that the combiner may be chosen automatically by the health insurance cost prediction program 110a, 110b.

In the present embodiment, for heightened privacy between the private source database 202 and the private target database 214, the health insurance cost prediction program 110a, 110b may build a prediction model for future health insurance costs in which trained source learner models may be passed to the transfer pipeline (i.e., transfer learner 228).

In the present embodiment, linear regression and least absolute shrinkage and selection operator (LASSO) models (i.e., a regression analysis method that may perform both variable selection and regularization) may be utilized as combiners, as well as literal regression or classification models depending on whether the predictions are continuous or categorical. The determination of which type of model may be utilized depends on which model may improve prediction accuracy and interpretability of a produced statistical model.

In the present embodiment, the source learner model 212 and the target learner model 224 may be trained utilizing the source and target data sets. The source and target training data sets may be utilized to obtain separate predictions for each of the two learners in which the source training data sets may obtain predictions associated with the source learner model 212, and the target training data sets may obtain predictions associated with the target learner model 224.

If the health insurance cost prediction program 110a, 110b determines that at least one set of source test data is created at 208, at least one set of target test data is created at 220, or the source learner model 212 and the target learner model 224 are combined to generate a transfer learner 228 at 226, then at least one prediction and/or evaluation is obtained at 230. The health insurance cost prediction program 110a, 110b may utilize a prediction module to evaluate the created and anonymized source and target test data sets, and the transfer learner 228. The transfer learner 228 (i.e., transfer learner model) may combine the predictions of the source learner model 212 and the target learner model 224 to analyze whether the predictions match the true outcomes on the novel data (i.e., unknown target). The output of the transfer learner 228 may include a set of predictions (e.g., predicted health insurance costs) to match the unknown target.

Continuing the previous example, the source learner model 212 generated for the millions of patients that underwent a quadruple bypass heart surgery, and the target learner model 224 generated for Customer A are combined to generate a transfer learner model 228. The training data sets from each learner model are compared. The factors in the source learner model 212 are given weight based on whether the same factors are present in the target learner model 224 associated with Customer A. Dissimilar factors are given less weight, while similar factors are given more weight. As such, data related to patients with similar medical complications, who were the same age (or within 10 years of Customer A's age), with the same cardiac surgeons performing the quadruple bypass heart surgery, or other similarly experienced and prestigious cardiac surgeons, may be given more weight. Based on the compared factors between the target learner model 224 and the source learner model 212, the following Table 1 related to the predicted health care costs associated with the quadruple bypass heart surgery undergone by Customer A is generated:

TABLE 1

| Treatment | Predicted Health Care Cost |
|---|---|
| Plaque removal from an artery | $45,592 |
| Heart bypass | $129,789 |
| Heart valve replacement due to medical | $171,542 |
| complication suffered by Customer A | |

Total Predicted Health Care Costs (excluding medications): $346,923

Then, at 232, a report is generated. The health insurance cost prediction program 110a, 110b may generate two types of reports (e.g., performance report and a scoring report). A scoring report may provide member-level predictions for each member in the data. The user may determine which report may be generated by the health insurance cost prediction program 110a, 110b.

A performance report may, however, describe the performance of the predictive model on novel data, which may vary from the training of the predictive model. The performance report may include aggregate performance measures (e.g., percentage of bias, R-squared, Mean Absolute Prediction Error (MAPE)), and performance measures on the ranking of the members based on the associated outputs (i.e., predicted costs vs. true costs). To generate a performance report, the health insurance cost prediction program 110a, 110b may utilize test data sets with ground truth outputs (i.e., outputs or information provided by direct observation or empirical evidence to confirm the accuracy of the classification of the training data set).

Continuing the previous example, the health insurance cost prediction program 110a, 110b utilizes the target and source test data, as well as the predictions generated by the transfer learner 228 to generate a performance report, which includes the above Table 1, as well as additional information that may affect the predicted health care costs and the numerical value related to the accuracy of the above predicted health care costs associated with Customer A.

In present embodiment, the health insurance cost prediction program 110a, 110b may, by default, generate both reports. However, the health insurance cost prediction program 110a, 110b may only generate a performance report if the true costs of the members in the test data set are known.

In the present embodiment, prior to generating the report, the user may be prompted (e.g., via dialog box) to indicate which type of report to generate. A dialog box, for example, may ask the user whether the user wants to customize the type of report generated. The dialog box may include a “Yes” button and “No” button under the question. If the user selects the “Yes” button, then another dialog box may appear which lists both types of reports. The user may select one of two types of reports and then may click the “Submit” button located at the bottom the dialog box. The dialog box may then disappear. If, however, the user selects the “No” button, then the dialog box may disappear and both reports, by default, may be generated.

In the present embodiment, if the health insurance cost prediction program 110a, 110b is unable to generate either or both reports, then an error message may be displayed, with an explanation or reason for why one or both reports may not be generated.

In the present embodiment, the health insurance cost prediction program 110a, 110b may utilize the aggregate performance measures of R-squared (i.e., coefficient of determination, denoted r² or R²) in which the proportion of the variation in the dependent variable may be predictable from at least one independent variable.

In the present embodiment, the health insurance cost prediction program 110a, 110b may utilize the aggregate performance measures of MAPE, which may include utilizing the following mathematical algorithm, for example, to provide a performance evaluation:

$$M = \frac{100}{n} {\sum }_{t = 1}^{n} \vert \frac{{A}_{t} - {F}_{t}}{{A}_{t}} \vert$$

For the above mathematical algorithm, A is the actual cost, F is the predicted cost and n is the number of members.

In the present embodiment, the health insurance cost prediction program 110a, 110b may present the performance and scoring reports as common-separated value (CSV) files to the end user.

In another embodiment, the health insurance cost prediction program 110a, 110b may present the report in another intuitive interface (e.g., charts, graphs) to the end user.

In another embodiment, the user may provide feedback to the health insurance cost prediction program 110a, 110b. As such, the user may improve the quality of the predictions made by the health insurance cost prediction program 110a, 110b. The user may provide feedback by clicking on a “User Feedback” button located on the bottom right side of the screen connected to the user device operating the health insurance cost prediction program 110a, 110b. Once the user clicks on the “User Feedback” button, the user may be prompted (e.g., via first dialog box) to indicate the predictions that the user feedback is associated with. The dialog box may include the list of recently generated predictions, and each recently generated prediction may include a button to the left in which the user may click to select that recently generated prediction. Once the user selects a recently generated prediction, the user may be prompted, (e.g., via second dialog box) to provide feedback on the selected recently generated prediction. The user may provide a written feedback in the comment box located in the center of the second dialog box, and may click the “Submit” button located directly under the comment box. The user may then be prompted (e.g., via third dialog box) whether the user intends to provide additional feedback associated with another recently generated prediction by clicking the “Yes” or “No” buttons in the third dialog box. Once the user clicks “No,” the first, second and third dialog box may disappear. If, however, the user selects the “Yes” button, then the user will return to the first dialog box to indicate the recently generated prediction that the user feedback is associated with.

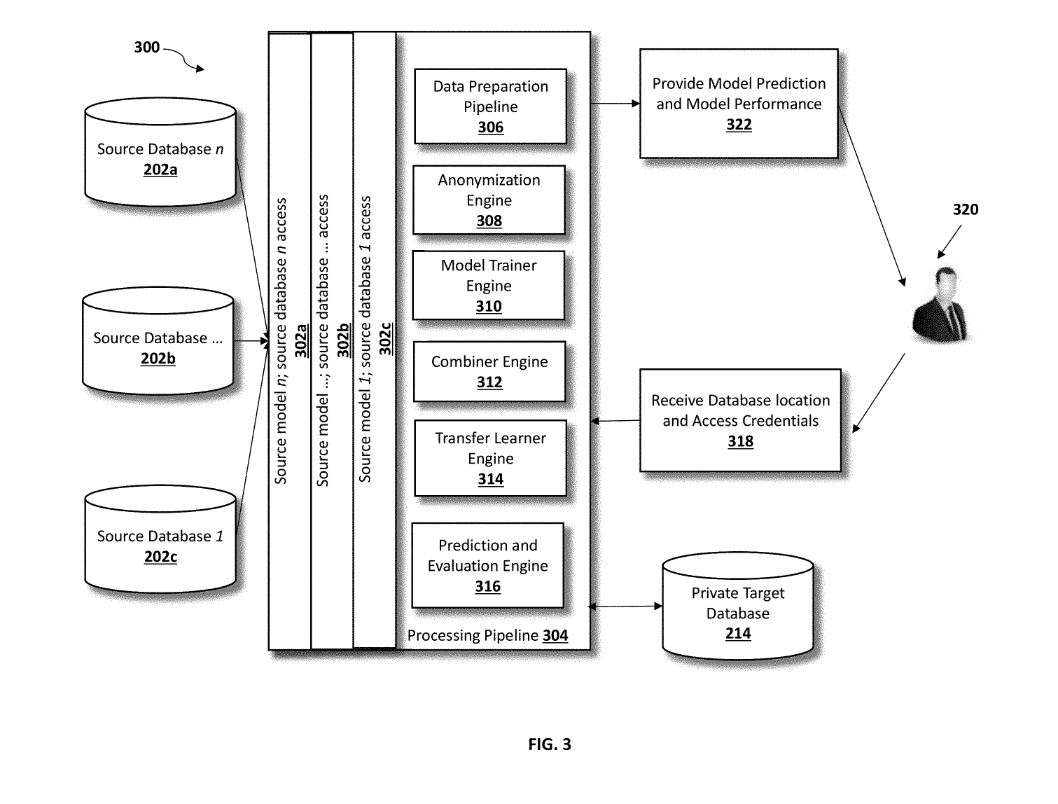

Referring now to FIG. 3, an operational flowchart illustrating the exemplary access level implementation process 300 used by the health insurance cost prediction program 110a, 110b according to at least one embodiment is depicted.

As shown, the health insurance cost prediction program 110a, 110b may interface with an end user 320. The first set of access layers may provide access to source models 302a, 302b and 302c and the corresponding source databases 202a, 202b and 202c by a processing pipeline 304. The processing pipeline 304 may include a data preparation pipeline 306, an anonymization engine 308, a model trainer engine 310, a combiner engine 312 (i.e., combiner), a transfer learner engine 314, and a prediction and evaluation engine 316.

The data preparation pipeline 306 may be utilized to clean and transform the data for predictive modelling, which may include common pre-processing operations (e.g., removal of records with missing attributes, imputation, verification of the integrity of values for each feature, conversion of some continuous attributes to categorical features for ease of modelling, creation of dummy-coded representations for categorical features, conversion of data to sparse matrices). The health insurance cost prediction program 110a, 110b may then utilize the anonymization engine 308 to sanitize the source data pulled from the source databases 202a, 202b and 202c, via communication network 116, to remove or encrypt personally identifiable information thereby protecting the anonymity of a person associated with the pulled source data. Then, the anonymized source data may be used by a model trainer engine 310 to generate the source learner model 212. The pulled and anonymized source data may then be aligned and filtered by the health insurance cost prediction program 110a, 110b utilizing a combiner engine 312. Additionally, the combiner engine 312 may combine one or more source learner models 212 with the target learner model 224 to generate a transfer learner 228.

The health insurance cost prediction program 110a, 110b may then utilize a transfer learner engine 314 to learn the combined model using the source and target data sets for future use with novel data. Then, the health insurance cost prediction program 110a, 110b may utilize the prediction and evaluation engine 316 to evaluate the anonymized target test data from the private target database 214 and the generated transfer learner model 228. The prediction and evaluation engine 316 may include the process of obtaining predictions from the generated transfer learner model 228 and the anonymized target test data, thereby generating the appropriate reports.

Additionally, the processing pipeline 304 may interface with a private target database 214, without exposing the source databases 202a, 202b and 202c to the private target database 214, or to the end user 320. The health insurance cost prediction program 110a, 110b may utilize the processing pipeline 304 to provide the end user 320 with the model prediction and model performance at 322, when the processing pipeline 304 receives the database location and access credentials at 318 from the end user 320.

In the present embodiment, the health insurance cost prediction program 110a, 110b, via the processing pipeline 304, may first receive the database location and access credentials at 318 from the end user 320 (e.g., via configuration file) before the health insurance cost prediction program 110a, 110b, via the processing pipeline 304, may provide a model prediction and model performance at 322 to the end user 320 (e.g., via CSV files).

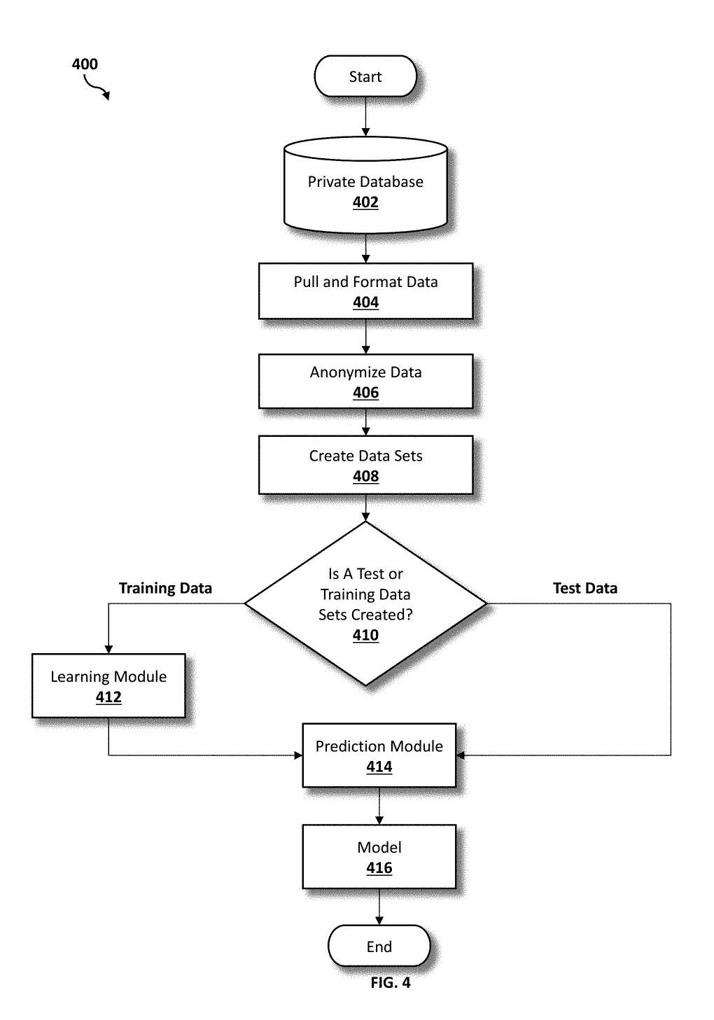

Referring now to FIG. 4, an operational flowchart illustrating the exemplary target and source data modelling performance process 400 used by the health insurance cost prediction program 110a, 110b according to at least one embodiment is depicted.

As shown, the health insurance cost prediction program 110a, 110b may train individual source and target models (i.e., source learner model 212 and target learner model 224) before combining the source learner model 212 and target learner model 224 into the transfer learner 228. At 404, using a software program 108 on the user's device (e.g., user's computer 102), data may be pulled from the respective private database 402, via communications network 116. The pulled data may then be formatted by a formatting engine.

Then, at 406, the pulled and formatted data may be anonymized by utilizing an anonymization engine 308, and the anonymized data may be used to create training or test data sets at 408. Next, at 410, the health insurance cost prediction program 110a, 110b determines whether at least one test or training data set is created. If, at 410, the health insurance cost prediction program 110a, 110b determines that at least one training data set is created, then the training data sets may be provided to a learning module 412 (i.e., model learner) that may generate a learned predictor that may be provided to a prediction module at 414.

In the present embodiment, the prediction module may, separately, receive the test data set if, at 410, the health insurance cost prediction program 110a, 110b determines that at least one test data set is created. Then, at 414, the prediction module may apply the learned predictor, derived from the training data set, or the test data set, and may generate a predictive model 416 (e.g., source learner model 212 or target learner model 224) based on the application.

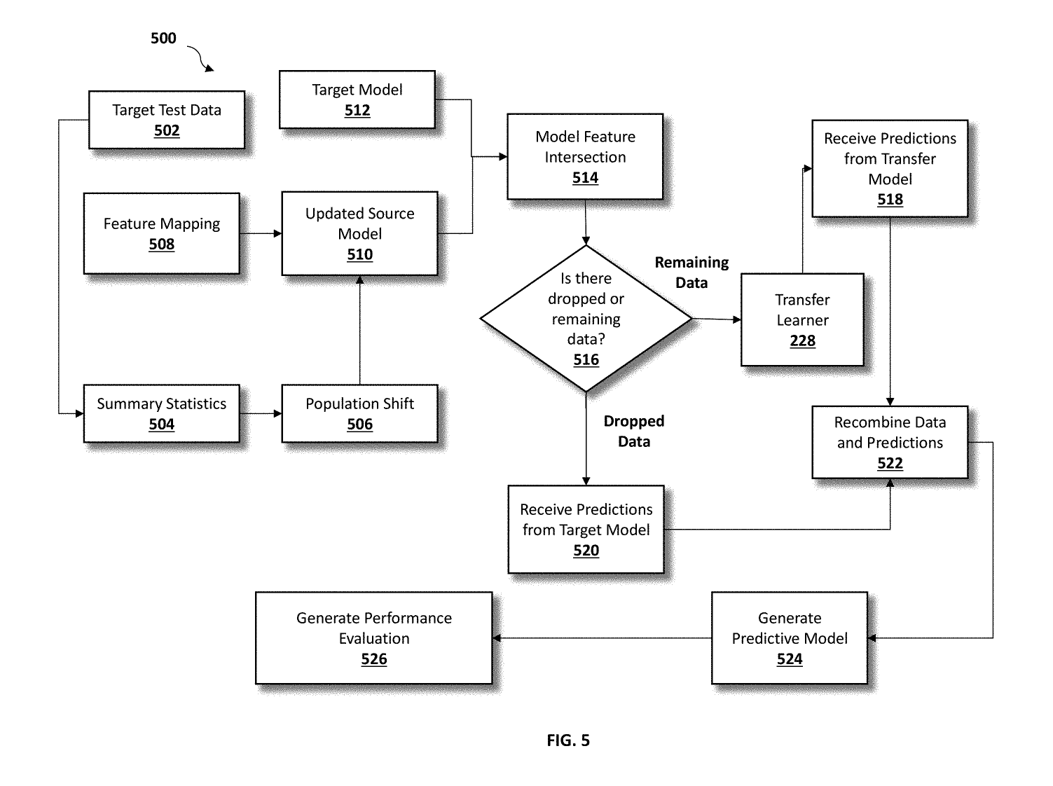

Referring now to FIG. 5, an operational flowchart illustrating the exemplary combiner utilization process 500 used by the health insurance cost prediction program 110a, 110b according to at least one embodiment is depicted.

As shown, the health insurance cost prediction program 110a, 110b may utilize the combiner engine 312 to combine the source learner model 212 (e.g., from at least one anonymized source training data set) and target learner model 224 (e.g., from at least one anonymized target training data set). Initially, a software program 108 on the user's device (e.g., user's computer 102) may be utilized to upload, as inputs, an output from feature mapping 508 and a population shift data set 506, via communications network 116, to generate an updated source model 510 (i.e., updated source learner model).

The features between the source and target data sets may exclude a one-to-one mapping between each data set. For example, when there are more or less insurance plan types in either of the health insurance data sets, the health insurance cost prediction program 110a, 110b may utilize the feature mapping module to explicitly map the plan types from the target data set to the source data set. Therefore, the source features may resemble the target features (as much as possible), which may be the output of the feature mapping 508.

The population from which the source data is drawn may have different characteristics compared to the target population. Therefore, the health insurance cost prediction program 110a, 110b may utilize the population shift module to re-weight the source data set (e.g., (xₛ, yₛ)), thereby causing the source data set to resemble the target data set (e.g., for true target data sets (xₜ, yₜ) or for deficient target data sets (x_{d}, y_{d})). Since the true target data set may not be observed, the program may utilize the deficient target data set, which has a distribution similar to that of true target. For re-weightings of the anonymized data, the health insurance cost prediction program 110a, 110b may utilize the following algorithms:

For anonymized source data (fₛ(x;θₛ)):

$$\frac{{\hat{p}}_{t} ( x , y )}{{\hat{p}}_{d} ( x , y )}$$

For anonymized target data (f_{d}(x;θ_{d})):

$$\frac{{\hat{p}}_{t} ( x , y )}{{\hat{p}}_{s} ( x , y )}$$

The results from the re-weighting with anonymized data may then be combined by utilizing the following algorithm:

$${argmin}_{{w}_{s} , {w}_{d} , {w}_{t} , {b}_{t}} {\sum }_{i} {( {y}_{i} - σ ( {x}_{i} ; {w}_{s} ) {f}_{s} ( {x}_{i} ; {θ}_{s} ) - σ ( {x}_{i} ; {w}_{d} ) {f}_{d} ( {x}_{i} ; {θ}_{d} ) - ℊ ( {x}_{i} ; {w}_{t} , {b}_{t} ) )}^{2}$$

The output of the population shift module may be the population shifted data set 506. For example, if the source data includes more people over the age of 65 whereas the target data includes more people under the age of 65, then the health insurance cost prediction program 110a, 110b may down-weight the people over the age of 65 and up-weight the people under the age of 65.

The population shifted data set 506 may be generated by using at least one set of summary statistics 504 derived from the target test data 502. The health insurance cost prediction program 110a, 110b may utilize the summary statistics module to feed to the population shift module.

In another embodiment, instead of providing the target test data 502 to the population shift module at 506, the health insurance cost prediction program 110a, 110b may summarize the target data and feed the target test data into the updated source model 510. Therefore, the health insurance cost prediction program 110a, 110b may serve two purposes: (a) the target test data may be a customer data set and may have policy constraints that prohibit a verbatim join with source data, or (b) the target test data may have unnecessary features that may be irrelevant to the population shift.

Then, the updated source model 510 (i.e., updated source learner model) and the target model 512 (i.e., target learner model 224) may be examined to identify a model feature intersection 514. The health insurance cost prediction program 110a, 110b may identify common features between the updated source model 510 and the target model 512 by utilizing the model feature intersection 514.

Then, at 516, the health insurance cost prediction program 110a, 110b determines whether the samples generated from the model feature intersection 514 include dropped (i.e., samples without the feature intersection data) or remaining data (i.e., samples with the feature intersection data). After mapping the features between the source and the target test data at 508, there may be some members in the target test data with features that fail to include mapping to the source data set. These members of the target test data may be excluded from use with the transfer learner 228 (i.e., dropped or samples without feature intersection data), and may instead obtain predictions solely from the target learner model (i.e., target model) 512.

If the health insurance cost prediction program 110a, 110b determines that the samples generated from the model feature intersection 514 include dropped data at 516, then the health insurance cost prediction program 110a, 110b may receive predictions from the target model 512 (e.g., predicted health care costs) (i.e., target predictions) at 520. The dropped data may be utilized as predictions from the target model 512 (e.g., predicted health care costs).

If, however, the health insurance cost prediction program 110a, 110b determines that the samples generated from the model feature intersection 514 include remaining data at 516, then the remaining data is used, as input, for the transfer learner 228. Using a software program 108 on the user's device (e.g., user's computer 102), the health insurance cost prediction program 110a, 110b may upload, as input, the remaining data associated with the samples generated by the model feature intersection 514 into the transfer learner 228 (i.e., transfer model), via the communication network 116. Then, at 518, the health insurance cost prediction program 110a, 110b may receive the output remaining data and predictions from the transfer learner 228 (i.e., transfer predictions).

Then, at 522, the health insurance cost prediction program 110a, 110b may recombine the remaining data and dropped data, and the predictions from the transfer learner 228 and the predictions from the target model at 520. The recombined data and predictions may generate a predictive model at 524 (i.e., model trained utilizing training data) which may then be utilized to generate a performance evaluation at 526 (e.g., performance and/or scoring reports since the member-level predictions are received).

In another embodiment, the source learner 212, target learner 224, and transfer learner model 228 may be stored on a separate database (e.g., database 114). Depending on the similarity of a new target data set with the existing target data set, the user may decide to utilize the same transfer learner 228. If the new and existing target data sets are sufficiently different, the health insurance cost prediction program 110a, 110b may train a new target learner 224 and transfer learner 228. The source learner 212 may be utilized, regardless of the differences between the new and existing target data sets.

It may be appreciated that FIGS. 2-5 provide only an illustration of one embodiment and do not imply any limitations with regard to how different embodiments may be implemented. Many modifications to the depicted embodiment(s) may be made based on design and implementation requirements.

FIG. 6 is a block diagram 900 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 6. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the health insurance cost prediction program 110a in client computer 102, and the health insurance cost prediction program 110b in network server 112, may be stored on one or more computer-readable tangible storage devices 916 for execution by one or more processors 906 via one or more RAMs 908 (which typically include cache memory). In the embodiment illustrated in FIG. 6, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the health insurance cost prediction program 110a, 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless Wi-Fi interface cards, or 3G or 4G wireless interface cards or other wired or wireless communication links. The software program 108 and the health insurance cost prediction program 110a in client computer 102 and the health insurance cost prediction program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the health insurance cost prediction program 110a in client computer 102 and the health insurance cost prediction program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third-party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third-party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

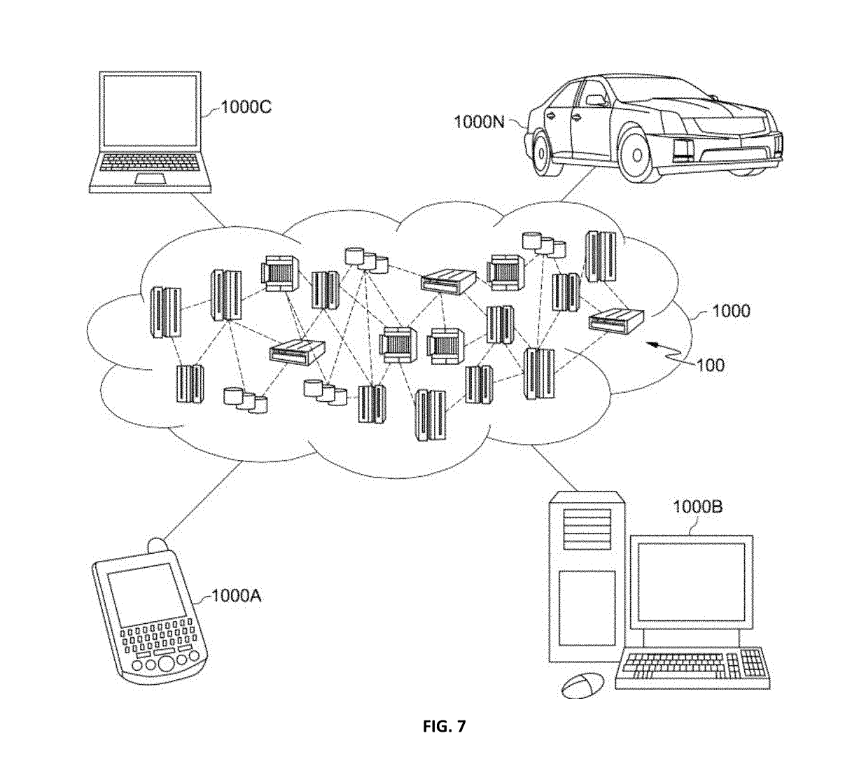

Referring now to FIG. 7, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 7 are intended to be illustrative only and that computing nodes 100 and cloud computing environment 1000 can communicate with any type of computerized device over any type of network and/or network addressable connection (e.g., using a web browser).

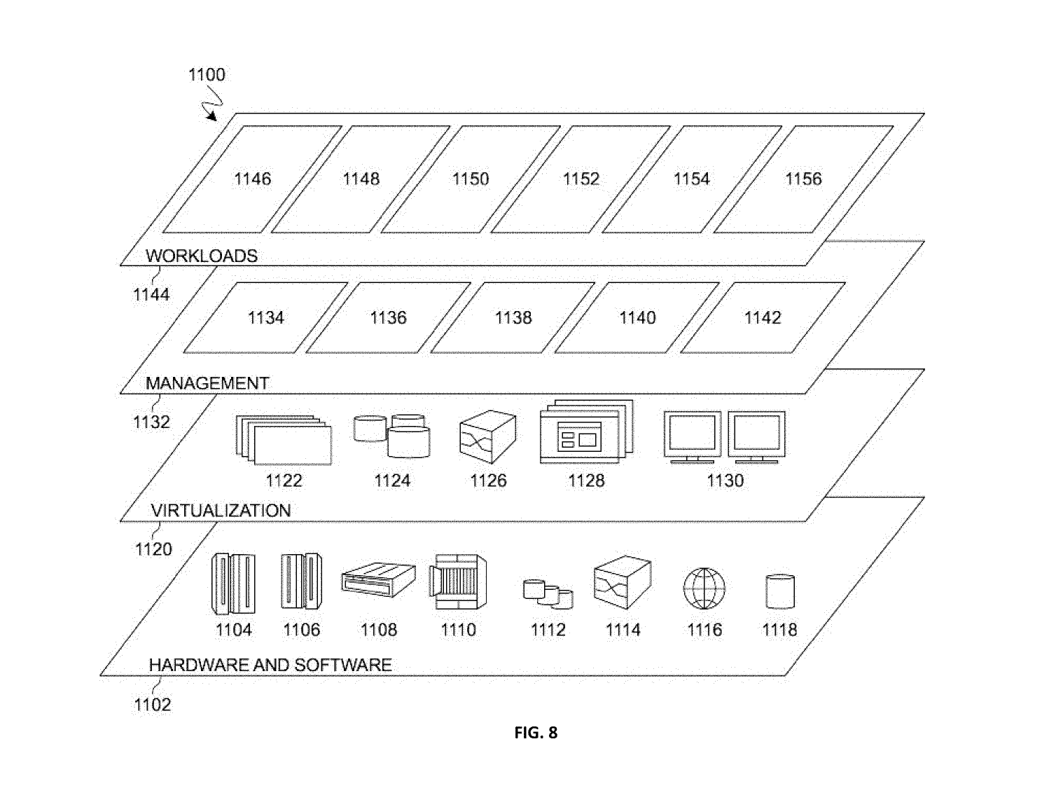

Referring now to FIG. 8, a set of functional abstraction layers 1100 provided by cloud computing environment 1000 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and health insurance cost prediction 1156. A health insurance cost prediction program 110a, 110b provides a way to report health insurance cost predictions via private transfer learning.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating and reporting a plurality of health insurance cost predictions via private transfer learning, the method comprising:
retrieving a set of source data from at least one private source database, and a set of target data from a private target database;
creating a plurality of source data sets from the retrieved set of source data, and at least one target data set from the retrieved set of target data;
anonymizing the created plurality of source data sets, and at least one created target data set;
in response to determining that at least one anonymized source training data set, and at least one anonymized target training data set is created, generating one or more source learner models based on the anonymized source training data set, and a target learner model based on the anonymized target training data set;
combining the one or more generated source learner models and the generated target learner model to generate a transfer learner; and
generating a prediction based on the generated transfer learner, wherein the generated prediction is evaluated for quality.

2. The method of claim 1, further comprising:
generating a report based on the generated prediction for the end user.

3. The method of claim 1, further comprising:
in response to receiving a database location and a plurality of access credentials from the end user, providing a model prediction and a model performance to the end user.

4. The method of claim 1, further comprising:
determining that at least one anonymized target test data set, and at least one anonymized source test data set is created;
generating a prediction based on the generated transfer learner based on the at least one determined source test data set and at least one determined target test data set, wherein the generated prediction is evaluated for quality; and
generating a report based on the evaluated prediction to the end user.

5. The method of claim 1, wherein combining the generated one or more source learner models and the generated target learner model to generate the transfer learner, further comprises:
aligning the one or more combined source learner models and the combined target learner model based on the features used in each learner model;
filtering data with the features absent on the one or more aligned source learner models and the aligned target learner model;
learning a set of weights and a set of methods to combine the aligned source learner model and the aligned target learner model based on the filtered data; and
generating the transfer learner based on the learned set of weights and learned set of models.

6. The method of claim 1, wherein creating the plurality of source data sets from the retrieved set of source data, and at least one target data set from the retrieved set of target data, further comprises:
cleaning the created plurality of source data sets and at least one created target data set by utilizing a data preparation pipeline; and
formatting the cleaned plurality of source data sets and at least one cleaned target data set for predictive modelling.

7. The method of claim 5, wherein learning the set of weights and the set of methods to combine the one or more aligned source learner models and the aligned target learner model based on the filtered data, further comprises:
generating a plurality of source features associated with the one or more aligned source learner models, and a plurality of target features associated with the aligned target learner model;
in response to mapping the generated plurality of source features to resemble the generated plurality of target features, generating feature mapping;
in response to determining that the anonymized source data set includes a plurality of different characteristics absent from a target population, generating at least one set of summary statistics by utilizing a summary statistics module;
generating at least one population shifted data set from at least one set of summary statistics to re-weight the anonymized source data; and
generating an updated source learner model based on the generated featuring mapping and at least one generated population shift data set.

8. The method of claim 7, further comprising:
identifying at least one model feature intersection by examining the generated updated source learner model and generated target learner model;
generating a plurality of samples from the at least one identified model feature intersection;
in response to determining that one or more of the generated plurality of samples include a piece of dropped data, removing the one or more generated plurality of samples including the piece of dropped data; and
receiving a plurality of target predictions from the target learner model based on the removed dropped data.

9. The method of claim 8, further comprising:
in response to determining that one or more of the generated plurality of samples include a piece of remaining data, receiving the piece of remaining data into the generated transfer learner; and
generating a plurality of transfer predictions from the transfer learner based on the received remaining data.

10. The method of claim 9, further comprising:
combining the generated plurality of target predictions and the generated plurality of transfer predictions;
generating a predictive model based on the combined plurality of target predictions and the generated plurality of transfer predictions; and
generating a performance evaluation based on the generated predictive model.

11. A computer system for generating and reporting a plurality of health insurance cost predictions via private transfer learning, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
retrieving a set of source data from at least one private source database, and a set of target data from a private target database;
creating a plurality of source data sets from the retrieved set of source data, and at least one target data set from the retrieved set of target data;
anonymizing the created plurality of source data sets, and at least one created target data set;
in response to determining that at least one anonymized source training data set, and at least one anonymized target training data set is created, generating one or more source learner models based on the anonymized source training data set, and a target learner model based on the anonymized target training data set;
combining the one or more generated source learner models and the generated target learner model to generate a transfer learner; and
generating a prediction based on the generated transfer learner, wherein the generated prediction is evaluated for quality.

12. The computer system of claim 11, further comprising:
generating a report based on the generated prediction for the end user.

13. The computer system of claim 11, further comprising:
in response to receiving a database location and a plurality of access credentials from the end user, providing a model prediction and a model performance to the end user.

14. The computer system of claim 11, wherein combining the generated one or more source learner models and the generated target learner model to generate the transfer learner, further comprises:
aligning the one or more combined source learner models and the combined target learner model based on the features used in each learner model;
filtering data with the features absent on the one or more aligned source learner models and the aligned target learner model;
learning a set of weights and a set of methods to combine the aligned source learner model and the aligned target learner model based on the filtered data; and
generating the transfer learner based on the learned set of weights and learned set of models.

15. The computer system of claim 11, wherein creating the plurality of source data sets from the retrieved set of source data, and at least one target data set from the retrieved set of target data, further comprises:
cleaning the created plurality of source data sets and at least one created target data set by utilizing a data preparation pipeline; and
formatting the cleaned plurality of source data sets and at least one cleaned target data set for predictive modelling.

16. The computer system of claim 14, wherein learning the set of weights and the set of methods to combine the one or more aligned source learner models and the aligned target learner model based on the filtered data, further comprises:
generating a plurality of source features associated with the one or more aligned source learner models, and a plurality of target features associated with the aligned target learner model;
in response to mapping the generated plurality of source features to resemble the generated plurality of target features, generating feature mapping;
in response to determining that the anonymized source data set includes a plurality of different characteristics absent from a target population, generating at least one set of summary statistics by utilizing a summary statistics module;
generating at least one population shifted data set from at least one set of summary statistics to re-weight the anonymized source data; and
generating an updated source learner model based on the generated featuring mapping and at least one generated population shift data set.

17. The computer system of claim 16, further comprising:
identifying at least one model feature intersection by examining the generated updated source learner model and generated target learner model;
generating a plurality of samples from the at least one identified model feature intersection;
in response to determining that one or more of the generated plurality of samples include a piece of dropped data, removing the one or more generated plurality of samples including the piece of dropped data; and
receiving a plurality of target predictions from the target learner model based on the removed dropped data.

18. The computer system of claim 17, further comprising:
in response to determining that one or more of the generated plurality of samples include a piece of remaining data, receiving the piece of remaining data into the generated transfer learner; and
generating a plurality of transfer predictions from the transfer learner based on the received remaining data.

19. The computer system of claim 18, further comprising:
combining the generated plurality of target predictions and the generated plurality of transfer predictions;
generating a predictive model based on the combined plurality of target predictions and the generated plurality of transfer predictions; and
generating a performance evaluation based on the generated predictive model.

20. A computer program product for generating and reporting a plurality of health insurance cost predictions via private transfer learning, comprising:
one or more computer-readable storage media and program instructions stored on at least one of the one or more tangible storage media, the program instructions executable by a processor to cause the processor to perform a method comprising:
retrieving a set of source data from at least one private source database, and a set of target data from a private target database;
creating a plurality of source data sets from the retrieved set of source data, and at least one target data set from the retrieved set of target data;
anonymizing the created plurality of source data sets, and at least one created target data set;
in response to determining that at least one anonymized source training data set, and at least one anonymized target training data set is created, generating one or more source learner models based on the anonymized source training data set, and a target learner model based on the anonymized target training data set;
combining the one or more generated source learner models and the generated target learner model to generate a transfer learner; and
generating a prediction based on the generated transfer learner, wherein the generated prediction is evaluated for quality.
